(19) United States
(12) Patent Application Publication
(10) Pub. No.: US 2010/0014858 A1
(43) Pub. Date: Jan. 21, 2010

(54) Reduction Of Packet Loss Through Optical Layer Protection

(76) Inventors: Giovanni Barbarossa, Saratoga, CA (US); Xiaodong Duan, Fremont, CA (US); Samuel Liu, San Jose, CA (US)

Correspondence Address: PATTERSON & SHERIDAN, LLP, 3040 POST OAK BLVD, SUITE 1500, HOUSTON, TX, 77056, US

(21) Appl. No.: 12/173,723

(22) Filed: Jul. 15, 2008

(51) Int. Cl. H04J 14/00

(52) U.S. Cl. 398/45

(57) ABSTRACT

Packet loss in an optical network transporting Ethernet-based data traffic is reduced using a switch in a transmitting node. When the transmitting node of the optical network detects a fault in an optical link, the switch buffers incoming data traffic until the optical link is reestablished. The switch may be an Ethernet switch that re-routes data traffic along one or more additional optical fibers that are connected in parallel with a defunct optical fiber to reestablish the optical link between two nodes. The switch may also be an optical switch that is configured to re-route optical data traffic from a defunct optical fiber to a redundant optical fiber.

### BACKGROUND OF THE INVENTION

1. Field of the Invention

Embodiments of the present invention relate generally to optical communication systems and, more particularly, to reduction of packet loss through optical layer protection.

2. Description of the Related Art

Optical networks are used extensively in telecommunications for voice and other applications. As the use of Ethernet as the data link layer for optical communication networks expands, the protection of Ethernet traffic on optical networks becomes important. This is particularly true for Gigabit Ethernet (GbE) applications, i.e., where Ethernet frames are transmitted at a rate of at least one gigabit per second, since large amounts of data can be lost when an optical link between network nodes is interrupted for even a few seconds.

Currently, one or more spare optical fibers between network nodes are used to provide protection of data traffic by creating a “self-healing” ring topology, wherein an alternate optical link is established between two nodes when an original link is severed or experiences a fault. Such self-healing ring topologies include the unidirectional path switched ring (UPSR) and the bidirectional line switched ring (BLSR). In either case, the optical layer of the network can reestablish the interrupted link using the spanning tree protocol (STP) inherent to layer-2 of the network. STP is an OSI (Open Systems Interconnection) layer-2 protocol that allows a network to include redundant links between nodes, providing automatic backup paths if an active link fails without the need for manually enabling and disabling these backup links. In synchronous optical networking (SONET), the STP healing process for the optical layer is on the order of 50 ms in duration. For optical networks carrying Ethernet-based traffic, however, the self-healing process is substantially longer.

In an optical network carrying Ethernet-based data traffic, if the optical “link-down” signal of a UPSR or BLSR is connected to the Ethernet router chip at each node, protection protocols, such as STP or RSTP, may take between 1 and 50 seconds to route traffic around a failure point. Even a 1 second recovery interval for a 1 GbE or 10 GbE optical network is an unacceptably long down-time, considering the quantity of data that is lost in this time period. If instead the optical link-down signal is not connected to the Ethernet router chip at each node, the optical layer and the Ethernet layer, i.e., the data link layer, are not integrated. Hence, the Ethernet layer operates independently of the optical layer, and will continue to send packets to a non-functioning optical link, causing even greater loss of packets as the UPSR or BLSR optical layer self-healing process is completed.

In light of the above, there is a need in the art for a method and apparatus to reduce Ethernet packet loss in optical networks

### SUMMARY OF THE INVENTION

Embodiments of the invention reduce packet loss in an optical network transporting Ethernet-based data traffic using a switch in a transmitting node. When the transmitting node of the optical network detects a fault in an optical link, the switch buffers incoming data traffic until the optical link is reestablished. The switch may be an Ethernet switch that re-routes data traffic along one or more additional optical fibers that are connected in parallel with a defunct optical fiber to reestablish the optical link between two nodes. The switch may also be an optical switch that is configured to re-route optical data traffic from a defunct optical fiber to a redundant optical fiber.

An optical network, according to an embodiment of the invention, includes a transmitting node, a receiving node, and first and second optical fibers for carrying optical signals from the transmitting node to the receiving node, wherein the transmitting node is configured to transmit optical signals onto the first optical fiber, and to switch an optical signal transmission path from the first optical fiber to the second optical fiber based on a condition of the first optical fiber.

A method for protecting against loss of data carried on optical fibers, according to an embodiment of the invention, includes the steps of buffering incoming optical data that was received for transmission through a first optical fiber upon detection of a fault in the first optical fiber, switching transmission path for the incoming optical data from the first optical fiber to a second optical fiber, and transmitting the incoming optical data through the second optical fiber.

Embodiments of the invention further provide an optical network node that includes an optical receiver for receiving input optical signals and generating electrical signals from the input optical signals, an Ethernet switch for receiving electrical signals from the optical receiver and selecting a transmission path based on information extracted from the electrical signals, and an optical transmitter for receiving electrical signals from the Ethernet switch and generating output optical signals from the electrical signals received from the Ethernet switch.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a partial block diagram of an optical network that uses remote detection for determining a cut fiber, according to an embodiment of the invention.

FIG. 1B is a partial block diagram of the optical network illustrated in FIG. 1A after a break occurs in an optical fiber.

FIG. 1C is a sequence diagram illustrating an optical layer healing process that uses remote detection to determine when a fiber is cut, according to one embodiment of the invention.

FIG. 2A is a partial block diagram of an optical network that uses local detection for determining a cut fiber, according to an embodiment of the invention.

FIG. 2B is a partial block diagram of the optical network illustrated in FIG. 2A after a break occurs in an optical fiber.

FIG. 2C is a flow diagram illustrating an optical layer healing process that uses local detection to determine when a fiber is cut, according to one embodiment of the invention.

FIG. 3 is a partial block diagram of an optical network, according to an embodiment of the invention, in which adjacent nodes are coupled via multi-link trunking.

FIG. 4A is a partial block diagram of an optical network, according to an embodiment of the invention, configured with an optical switch and a redundant optical fiber, according to an embodiment of the invention.

FIG. 4B illustrates a partial block diagram of an optical network configured with optical layer protection that uses a redundant optical fiber positioned between two nodes and an optical switch disposed in the receiving node, according to an embodiment of the invention.

FIGS. 5A and 5B are partial block diagrams of optical networks, according to embodiments of the invention, configured with optical switches and redundant optical fibers for optical layer protection of two optical links between a transmitting node and a receiving node.

For clarity, identical reference numbers have been used, where applicable, to designate identical elements that are common between figures. It is contemplated that features of one embodiment may be incorporated in other embodiments without further recitation.

### DETAILED DESCRIPTION

Embodiments of the invention contemplate a method and apparatus to reduce packet loss in an optical network transporting Ethernet-based data traffic. When a fault is detected in an optical link by a transmitting node of an optical network, an Ethernet switch contained in the transmitting node is configured to buffer incoming data traffic until the optical link is reestablished. In one embodiment, the Ethernet switch re-routes data traffic along one or more additional optical fibers that are connected in parallel with a defunct optical fiber to reestablish the optical link between two nodes. In another embodiment, the optical link is reestablished by means of an optical switch incorporated into the transmitting node, the optical switch being configured to re-route optical data traffic from a defunct optical fiber to a redundant optical fiber.

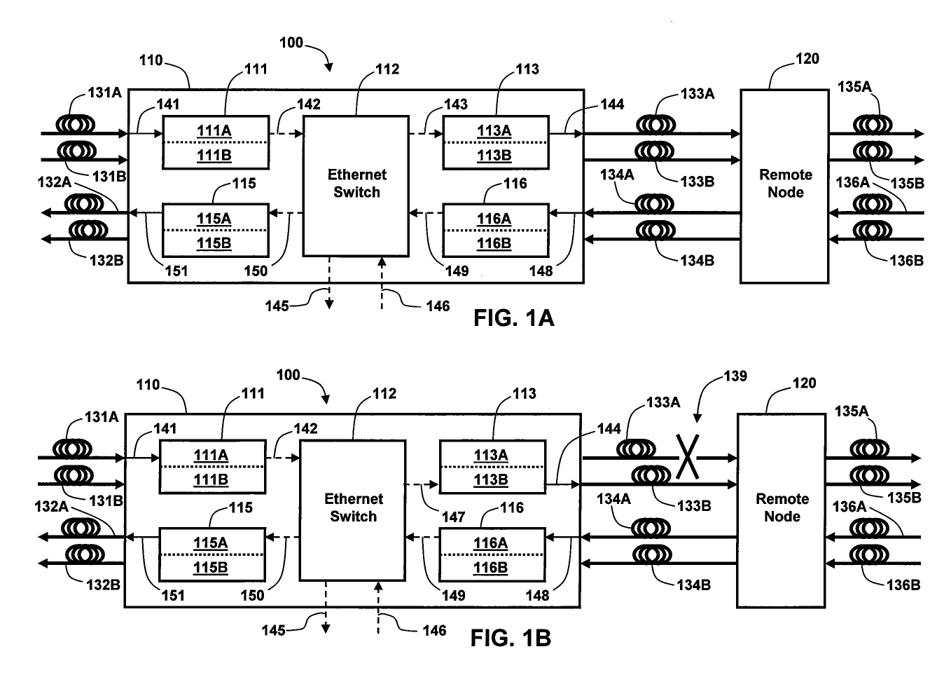

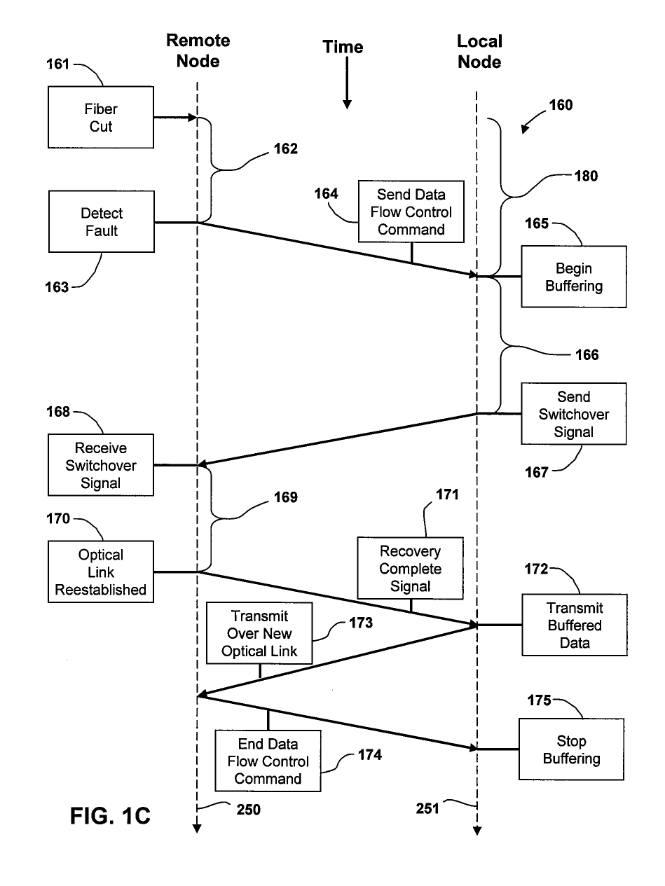

FIG. 1A is a partial block diagram of an optical network 100 that uses remote detection for determining a cut fiber, according to an embodiment of the invention. Dashed arrows, e.g., 142 and 143, represent pathways of electrical or electronic signals, and solid arrows, e.g., 141 and 144, represent optical signals. Optical network 100 is an Ethernet-based network, where the signal traffic carried thereby is organized in data frames, or “packets,” according to an Ethernet protocol, such as 1 GbE or 10 GbE, as defined by IEEE 802.3-2005. Optical network 100 includes a local node 110, a remote node 120, and a plurality of optical fibers 131A,B-136A,B that optically couple optical network 100, local node 110, and remote node 120, as shown. Optical network 100 is configured to carry unidirectional traffic, i.e., optical signals only travel one direction in each optic fiber making up the network. It is understood that for purposes of explanation, any node in optical network 100 can be considered a “local node” and each node adjacent thereto can be considered a “remote node.”

Local node 110 includes optical receiver arrays 111, 116, an Ethernet switch 112, and optical transmitter arrays 113, 115. Local node 110 is coupled to an adjacent node (not shown) of optical network 100 via optical fibers 131A, 132A and redundant optical fibers 131B, 132B, and is coupled to remote node 120 via optical fibers 133A, 134A and redundant optical fibers 133B, 134B. Optical fiber 131A and redundant optical fiber 131B are coupled to optical receivers 111A, 111B, respectively, and optical fiber 133A and redundant optical fiber 133B are coupled to optical transmitters 113A, 113B, respectively. Optical fiber 134A and redundant fiber 134B are coupled to optical receivers 116A, 116B, respectively, and optical fiber 132A and redundant fiber 132B are coupled to optical transmitters 115A, 115B, respectively. During normal operation, optical input signal 141 is received by optical receiver 111A via optical fiber 131A, converted into electronic input signal 142, and transmitted to Ethernet switch 112 for routing, while redundant optical fiber 131B remains idle. Similarly, optical input signal 148 is received by optical receiver 116A via optical fiber 134A, converted into electronic input signal 149, and transmitted to Ethernet switch 112 for routing, and redundant optical fiber 134B remains idle. Optical input signals 141, 148 are optical signals containing one or more data streams of Ethernet packets, each data stream being dedicated for delivery to a particular node of optical network 100. Electronic input signal 142 contains the same data streams of Ethernet packets in optical input signal 141, but in electronic form, and electronic input signal 149 contains the same data streams of Ethernet packets in optical input signal 148.

Upon receiving electronic input signals 142, 148, Ethernet switch 112 then routes each packet contained therein according to destination data embedded in each Ethernet packet, such as a VLAN tag or other header information. For example, when local node 110 is a pass-through node, i.e., data traffic is neither added to nor dropped from the data streams passing therethrough, Ethernet switch 112 routes all packets contained in electronic input signals 142, 149 to electronic output signal 143, 150, respectively. Electronic output signal 143 is then transmitted to optical transmitter array 113 and electronic output signal 150 to optical transmitter array 115. In an alternate embodiment, local node 110 may be an add/drop node, in which case Ethernet switch 112 receives packets from both electronic input signals 142, 149, and added signal 146, and routes each received packet to either electronic output signals 143, 150 or dropped signal 145. Added signal 146 includes one or more data streams of Ethernet packets that are introduced into optical network 100 at local node 110. Dropped signal 145 is made up of packets from electronic input signal 142 whose destination node is local node 110. For an add/drop node, electronic output signal 143 is made up of packets from electronic input signal 142 and added signal 146 whose destination node is downstream of local node 110, and is transmitted to optical transmitter 113A for conversion to optical output signal 144. In another embodiment, local node 110 may be a junction node, in which case added signal 146 includes one or more data streams of Ethernet packets that are converted from an optical signal received by local node 110 from another upstream node (not shown) of optical network 100. Similar to an add/drop node, in this embodiment Ethernet switch 112 sorts packets from electronic input signals 142, 149 to either electronic output signals 143, 150, or dropped signal 145, and routes packets from added signal 146 to either electronic output signal 143 or 150.

Whether local node 110 is a pass-through, add/drop, or junction node, optical transmitter 113A converts electronic output signal 143 to optical output signal 144, and transmits the optical signal via optical fiber 133A to remote node 120, remote node 120 being the downstream node adjacent to local node 110. During normal operation of optical network 100, redundant optical fibers 133B, 134B are idle.

FIG. 1B is a partial block diagram of optical network 100 after a break 139 occurs in optical fiber 133A. Break 139 stops data traffic along optical fiber 133A, but through the optical layer self-healing protocol described below in conjunction with FIG. 1C, data traffic is re-routed to remote node 120 along redundant fiber 133B to restore the optical link between local node 110 and remote node 120. To that end, Ethernet switch 112 transmits electronic output signal 147 to optical transmitter 113B, where electronic output signal 147 contains the data traffic previously carried by electronic output signal 143, described above in conjunction with FIG. 1A. Optical transmitter 113B converts electronic output signal 147 to optical output signal 144 and transmits optical output signal 144 to remote node 120 via redundant fiber 133B. In this way, the optical layer of optical network 100 is healed between local node 110 and remote node 120 without reliance on a conventional layer-2 protocol, such as STP or RSTP.

FIG. 1C is a sequence diagram illustrating an optical layer healing process 160 that uses remote detection to determine when a fiber is cut, according to one embodiment of the invention. Optical layer healing process 160 is carried out by local node 110 whenever remote node 120 detects a loss of signal (LOS), signal degrade (SD), or other fault, or when receiving power from remote node 120 drops to zero. Because optical fibers in optical network 100 are used to carry unidirectional traffic, optical layer healing process 160 is based on remote detection of break 139. Vertical lines 250, 251 represent the passage of time for remote node 120 and local node 110, respectively, with time flowing from top to bottom of FIG. 1C. In this example, it is assumed that, in addition to transmitting and receiving optical output signal 144 and optical input signal 148 as described above, local node 110 is configured to transmit and receive an optical supervisor channel (OSC) that periodically transmits information required to manage the optical link between local node 110 and remote node 120.

In step 161, optical fiber 133A is cut, as shown in FIG. 1B. At this time, local node 110 is operating normally. Ethernet switch 112 is selectively transmitting packets to optical transmitter 113A, and optical transmitter 113A is transmitting the same packets as an optical signal over optical fiber 133A. Because optical fiber 133A is cut or otherwise damaged, these packets are lost.

In step 163, after time interval 162, remote node 120 detects that receiving power from optical transmitter 116A has dropped to zero due to the failure of optical fiber 133A. The duration of time interval 162 is typically about 0.4 ms.

In step 164, an optical transmitter in remote node 120 transmits a data flow control command to local node 110 via optical fiber 134A.

In step 165, Ethernet switch 112 in local node 110 receives the data flow control command. Under the data flow control command, Ethernet switch 112 ceases transmission of packets to optical transmitter 113A and begins buffering data packets that would normally be routed to electronic output signal 143, i.e., data packets received from electronic input signal 142 and added signal 146 whose destination node is remote node 120. At this point, packets are no longer lost due to transmission over a damaged or inoperable optical fiber. It is noted that the duration of repair period 180, which is the time during which packets are lost, is very short relative to the 1 to 50 second repair period associated with STP. Because the total time during which packets are lost is less than about 1 ms, data loss suffered when a 10 GbE signal is interrupted by cable failure can be reduced to less than 100 Kbytes. Similarly, data loss suffered when a 1 GbE signal is interrupted by cable failure can be reduced to less than 10 Kbytes.

During switchover time 166, Ethernet switch 112 reassigns the VLAN tag assignment of buffered data with the destination information corresponding to optical transmitter 113B, so that the buffered data packets will be routed to optical transmitter 113B rather than optical transmitter 113A. The duration of time interval 166, which is the switchover time required by Ethernet switch 112 to reassign the VLAN tags of the buffered data packets, is less than 1 ms.

In step 167, switchover by Ethernet switch 112 is complete, and local node 110 transmits a signal to remote node 120 via optical transmitter 113B and redundant fiber 133B indicating that switchover is complete.

In step 168, remote node 120 receives switchover complete signal from local node 110.

In step 170, after time interval 169, remote node 120 receives confirmation that the optical link between optical transmitter 113B and remote node 120 has been reestablished. Confirmation thereof is received via OSC data received via redundant fiber 133B.

In step 171, remote node 120 transmits a recovery complete signal to local node 110.

In step 172, local node 110 receives the recovery complete signal from remote node 120 and Ethernet switch 112 begins transmitting electronic output signal 147 to optical transmitter 113B, as illustrated in FIG. 1B. Electronic output signal 147 includes buffered data buffered by Ethernet Switch 112.

In step 173, optical transmitter 113B in local node 110 receives electronic output signal 147, converts the electronic signal to optical output signal 144, and begins transmitting optical output signal 144 to remote node 120 over the new optical link established via redundant fiber 133B, as illustrated in FIG. 1B.

In step 174, once remote node 120 begins receiving optical output signal 144 via the new optical link, remote node 120 transmits an end data flow control command to local node 110.

In step 175, local node 110 receives the end data flow control command and Ethernet switch 112 stops buffering electronic output signal 147.

It is noted that, in this embodiment, the operation of Ethernet switch 112 is coupled to an optical component of local node 110, i.e., optical transmitter array 113. Consequently, the optical layer of optical network 100 does not operate independently from the L-2, or data link layer. In this way, it is not necessary for optical network 100 to rely on substantially slower conventional optical layer protections, such as STP or RSTP, to reestablish the optical link between local node 110 and remote node 120 when optical fiber 133A is cut or otherwise damaged, thereby reducing packet loss in such a situation.

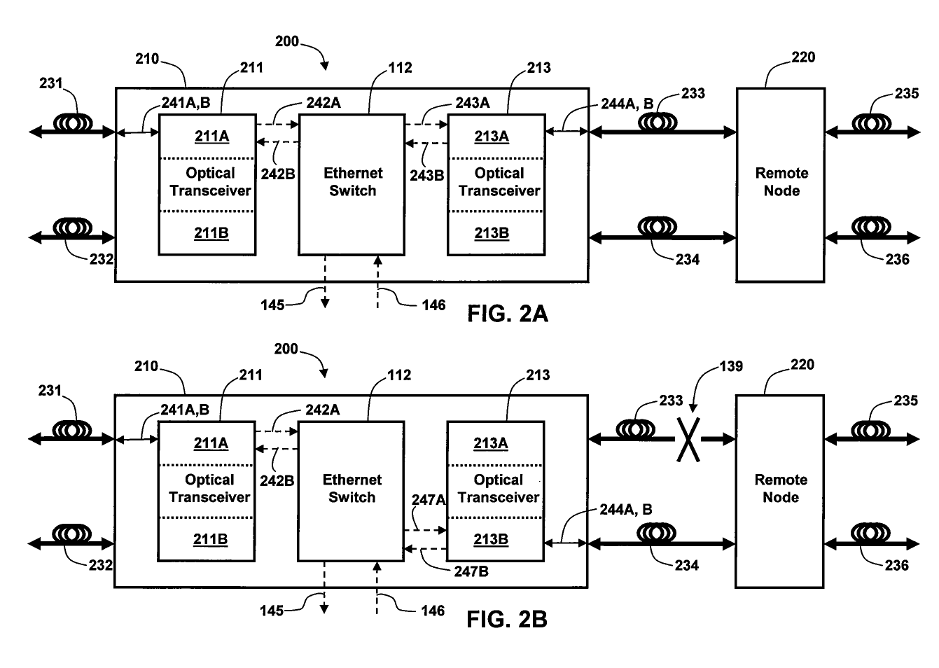

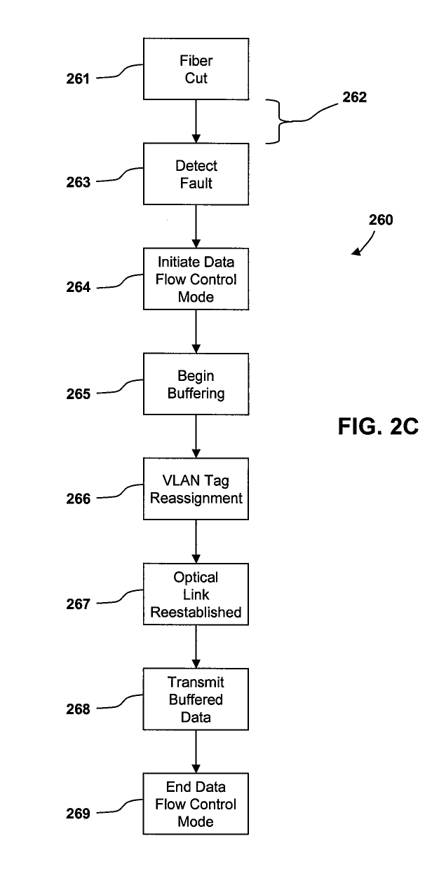

In another embodiment, it is contemplated that an optical network can rely on local detection to determining if a fiber is cut and initiate an optical layer healing process. FIG. 2A is a partial block diagram of an optical network 200 that uses local detection for determining a cut fiber, according to an embodiment of the invention. Optical network 200 is similar in organization and operation to optical network 100, described above in conjunction with FIGS. 1A-C, and elements common to optical networks 100 and 200 have been given identical element labels. Optical network 200 primarily differs from optical network 100 in that each optical link established between adjacent nodes in optical network 200 is configured to carry bidirectional data traffic, i.e., optical signals travel both directions in each optic fiber making up the network. Thus, local node 210 is coupled to an adjacent node (not shown) of optical network 200 via optical fiber 231 and redundant optical fiber 232, and is coupled to remote node 220 via optical fiber 233 and redundant optical fiber 234. In addition, local node 210 includes optical transceiver arrays 211, 213 instead of separate optical transmitter and optical receiver arrays.

During normal operation, an optical signal 241A is received by an optical transceiver 211A via optical fiber 231, converted into electronic signal 242A, and transmitted to Ethernet switch 112 for routing, while redundant optical fiber 232 remains idle. Similarly, optical signal 244B is received by optical transceiver 213A via optical fiber 233, converted into electronic signal 243B, and transmitted to Ethernet switch 112 for routing, and redundant optical fiber 234 remains idle. As described above in conjunction with FIGS. 1A-C, Ethernet switch 112 routes electronic signals as desired and transmits electronic signals accordingly. For example, Ethernet switch 112 receives electronic signals 242A, 243B, and added signal 145, and transmits electronic signals 242B, 243A, and dropped signal 146, each of the transmitted electronic signals containing the desired data traffic. Optical transceiver 211A converts electronic signal 242B to optical signal 241B and optical transceiver 213A converts electronic signal 243A to optical signal 244A and transmits optical signal 244A to receiving node 220 via optic fiber 233.

Optical layer protection is provided to optical network 200 by re-routing data traffic from a non-functioning optical link to a redundant optical link. FIG. 2B is a partial block diagram of optical network 200 after a break 139 occurs in optical fiber 233. Break 139 stops data traffic along optical fiber 233 in both directions. Through the optical layer self-healing protocol described below in conjunction with FIG. 2C, data traffic is re-routed to and from remote node 220 along redundant fiber 234 and via electronic signals 247A, B to restore the optical link in both directions between local node 210 and remote node 220.

FIG. 2C is a flow diagram illustrating an optical layer healing process 260 that uses local detection to determine when a fiber is cut, according to one embodiment of the invention. Optical layer healing process 260 is carried out by local node 210 whenever local node 210 detects a loss of signal (LOS), signal degrade (SD), or other fault, or when receiving power from remote node 220 drops to zero. Because optical fibers in optical network 100 are used to carry bidirectional traffic, optical layer healing process 260 may be based on either remote detection or local detection of break 139.

In step 261, optical fiber 233 is cut, as shown in FIG. 2B. At this time, local node 210 is operating normally. Ethernet switch 112 is selectively transmitting packets to optical transceiver 213A, and optical transceiver 213A is transmitting the same packets as an optical signal over optical fiber 233. Because optical fiber 233 is cut or otherwise damaged, these packets are lost.

In step 263, after time interval 262, local node 210 detects that receiving power from remote node 220 has dropped to zero due to the failure of optical fiber 233. The duration of time interval 262 is typically about 0.4 ms.

In step 264, local node 120 switches to data flow control mode.

In step 265, under the data flow control command, Ethernet switch 112 in local node 210 ceases transmission of packets to optical transceiver 213A and begins buffering data packets that would normally be routed to electronic signal 243A, i.e., data packets received from electronic signals 242A and added signal 146 whose destination node is remote node 220. At this point, packets are no longer lost due to being transmitted over a damaged or inoperable optical fiber. Because the duration of the repair period during which packets are lost is less than about 1 ms, data loss suffered when a 10 GbE signal is interrupted by cable failure can be reduced to less than 100 Kbytes. Similarly, data loss suffered when a 1 GbE signal is interrupted by cable failure can be reduced to less than 10 Kbytes.

In step 266, Ethernet switch 112 reassigns the VLAN tag assignment of buffered data with the destination information corresponding to optical transceiver 213B, so that the buffered data packets will be routed to optical transceiver 213B rather than optical transceiver 213A.

In step 267, an optical link between local node 210 and remote node 220 is reestablished. The optical link may be reestablished by transmission of an OSC signal via redundant optical fiber 234.

In step 268, Ethernet switch 112 in local node 210 begins transmitting electronic signal 247A to optical transceiver 213B for transmission to remote node 220 as optical signal 244B, as illustrated in FIG. 2B. Electronic signal 247A includes buffered data buffered by Ethernet Switch 112.

In step 269, after transmission of buffered data is complete, local node 210 switches out of data flow control mode and stops buffering data to be routed to remote node 220.

Thus, with a down time of less than about 1 ms, packet loss in optical network 200 can be greatly reduced over substantially slower conventional optical layer protections, such as STP or RSTP.

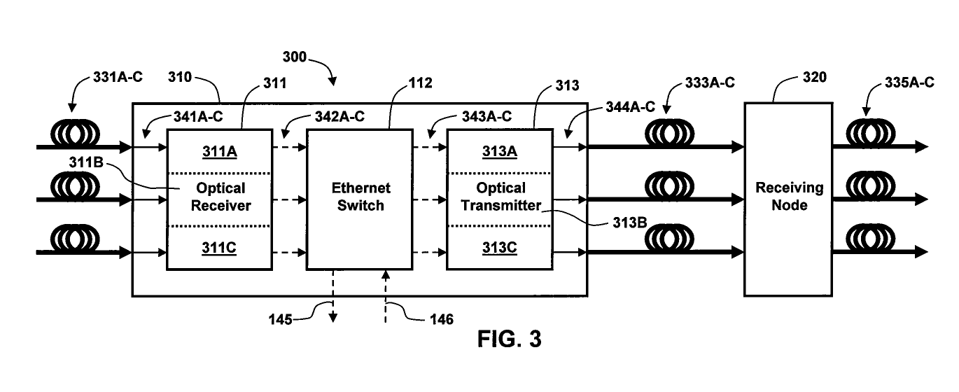

FIG. 3 is a partial block diagram of an optical network, according to an embodiment of the invention, in which adjacent nodes are coupled via multi-link trunking. For simplicity, only data traffic in a single direction is depicted. Optical network 300 is an Ethernet-based network similar to optical network 100, described above in conjunction with FIGS. 1A-C, and elements common to optical networks 100 and 300 have been given identical element labels. Optical network 300 primarily differs from optical network 100 in that adjacent nodes of optical network 300 are coupled by multiple active optical links, and redundant optical links are not provided between adjacent nodes for protection. Rather, each optical link established between adjacent nodes is configured to carry data traffic therebetween. Optical layer protection is provided to optical network 300 by re-routing data traffic from a non-functioning optical link to the remaining active optical links via the Ethernet switch positioned upstream of the non-functioning optical link. Such data traffic re-routing is possible since the optical layer and the data link layer (i.e., the Ethernet layer) do not operate independently.

Optical network 300 includes a transmitting node 310, a receiving node 320, and a plurality of optical fibers 331A-C, 333A-C, and 335A-C that optically couple optical network 300, transmitting node 310, and receiving node 320, as shown. Traffic between nodes in optical network 300 is distributed between multiple optical fibers. Optical fibers 331A-C carry data traffic from an upstream node to transmitting node 310, optical fibers 333A-C carry data traffic from transmitting node 310 to receiving node 320, and optical fibers 335A-C carry data traffic from receiving node 320 to a downstream node. An optical network having more or fewer than three optical links between each node is also contemplated.

In operation, optical receivers 311A-C receive optical input signals 341A-C, respectively via optical fibers 331A-C, respectively, and convert said signals into electronic input signals 342A-C, respectively. Ethernet switch 112 receives and routes the data packets contained in electronic input signals 342A-C and added signal 146 to electronic output signals 343A-C as appropriate. Optical transmitters 313A-C receive electronic output signals 343A-C, respectively, and convert said signals into optical output signals 344A-C for transmission via optical fibers 333A-C, respectively. In the event of data traffic interruption between transmitting node 310 and receiving node 320 due to a non-operational optical fiber, the interrupted data traffic is redistributed by Ethernet switch 112 to one or more of the remaining active optical links. For example, if optical fiber 333A is damaged and is no longer an active optical link between transmitting node 310 and receiving node 320, Ethernet switch 112 reroutes the data packets contained in electronic output signal 343A to electronic output signals 343B and/or 343C, as necessary. Ethernet switch 112 reroutes the interrupted data traffic in a manner similar to that described above for local node 110 in FIGS. 1A, 1B.

In this embodiment, interrupted data traffic is processed by Ethernet switch 112 in a manner substantially similar to the treatment of overflow data traffic from one of multiple parallel optical links. Thus, optical layer protection is provided to optical network 300 without the need for redundant, underutilized optical links, thereby reducing the effective cost of optical layer protection for optical network 300.

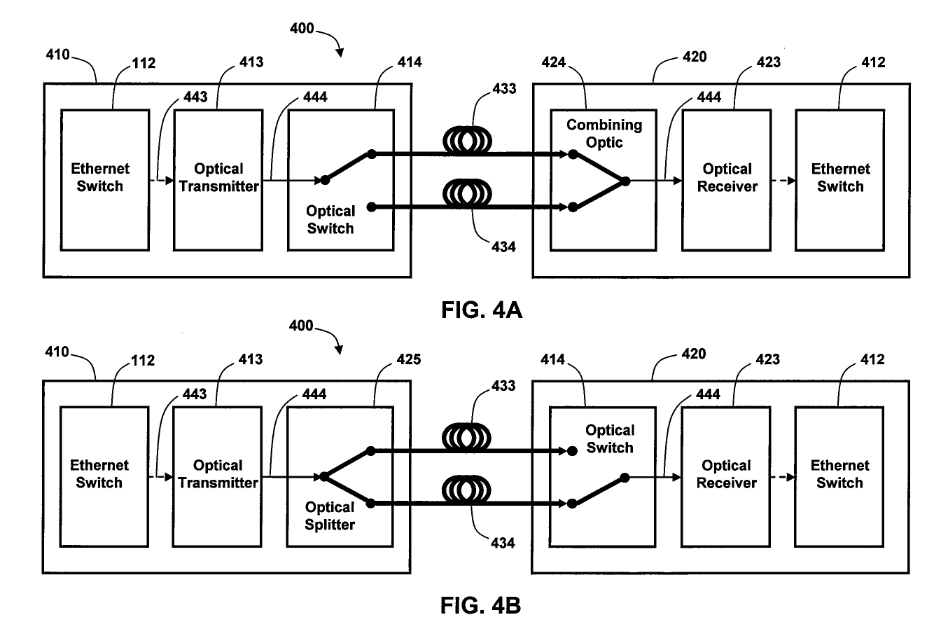

In one embodiment of the invention, an optical link is reestablished between adjacent nodes in an optical network by means of an in-line optical switch incorporated into the transmitting node, where the optical switch is configured to re-route optical data traffic from a non-functioning optical fiber to a redundant optical fiber. Optical layer protection can be performed with either remote or local fault detection. FIG. 4A illustrates a partial block diagram of an optical network 400 configured with an optical switch and a redundant optical fiber for optical layer protection of an optical link between a transmitting node 410 and a receiving node 420, according to an embodiment of the invention. In FIG. 4A, optical network 400 is configured for remote fault detection. Transmitting node 410 and receiving node 420 are substantially similar in organization and operation to local node 110 and remote node 120, respectively, as illustrated in FIGS. 1A, 1B, with the exception of an optical switch 414 and a combining optic 424. For simplicity, only data traffic in a single direction is depicted. Transmitting node 410 includes an Ethernet switch 112, an optical transmitter 413, and optical switch 414, and receiving node 420 includes an Ethernet switch 412, an optical receiver 423, and combining optic 424. An optical link couples transmitting node 410 and receiving node 420.

In normal operation, the optical link is maintained via optical fiber 433, as shown. Ethernet switch 112 transmits an electrical output signal 443 to optical transmitter 413, and optical transmitter 413 converts electronic output signal 443 to optical output signal 444. Optical output signal 444 is optically coupled to optical switch 414, which routes the optical signal to receiving node 410 via optical fiber 433. In the event of a cut or break in optical fiber 433, transmitting node 410 is configured to reestablish the optical link between transmitting node 410 and receiving node 420 via optical fiber 434. When transmitting node 410 detects a fault on optical fiber 433, or when receiving power from receiving node 433 drops to zero, Ethernet switch 112 is given a data flow control command. Under the data flow control command, Ethernet switch 112 ceases transmission of data packets to optical transmitter 413, and begins buffering incoming data traffic until the optical link between transmitting node 410 and receiving node 420 is reestablished. Optical switch 414 reestablishes the interrupted optical link by optically coupling optical fiber 434 to transmitting node 410. Because the optical switchover process can have a duration of about 3 ms, Ethernet switch 112 continues to buffer incoming data traffic until the optical switchover process is complete and the optical link between transmitting node 410 and receiving node 420 is reestablished, thereby minimizing packet loss. Packet loss is minimized since Ethernet switch 112 buffers data traffic during the process of healing the optical layer. Packets are only lost during the time period between the initial fault or break in optical fiber 433 occurring and the data flow control command being received by Ethernet switch 112, which may be less than 1 ms.

In the embodiment illustrated in FIG. 4A, remote detection of a fiber cut is used, since the optical switch is disposed in the transmitting node and the receiving node will determine a fiber is cut when received power drops to zero. Thus, the optical layer healing process 160 in FIG. 1C, which is a remote detection process, can be performed by receiving node 420. Alternatively, local detection of a fiber cut can be used when optical network 400 is configured as illustrated in FIG. 4B. FIG. 4B illustrates a partial block diagram of an optical network 400 configured with optical layer protection that uses a redundant optical fiber positioned between two nodes and an optical switch disposed in the receiving node. Because receiving node 420 is configured with optical switch 414, fiber breaks between receiving node 420 and transmitting node 410 can be detected locally by receiving node 420. That is, optical switch 414 may be controlled locally by the node that detects the fiber cut, in this case receiving node 420. Transmitting node 410 is configured with a splitter device 425 to optically couple transmitting node 410 to either optical fiber 433 or optical fiber 434. Thus, the optical layer healing process 260 in FIG. 2C, which is a local detection process, can be performed by receiving node 420.

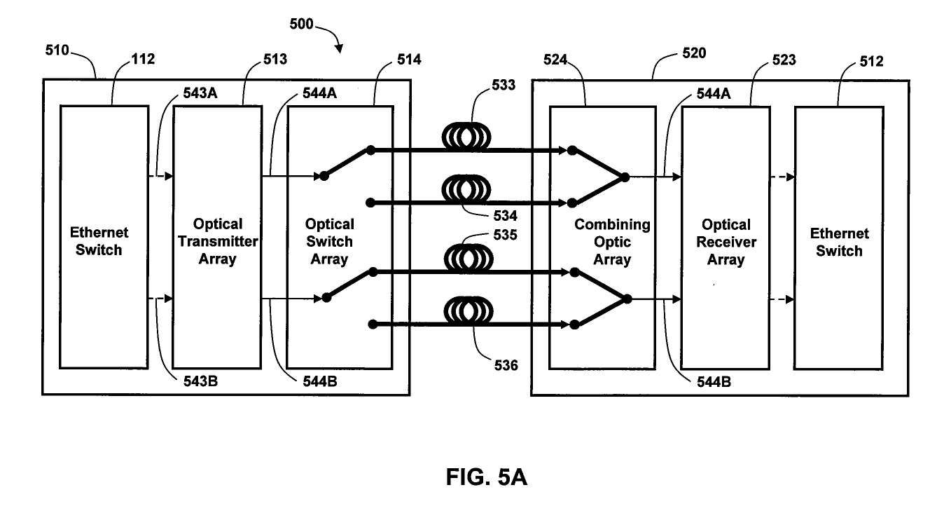

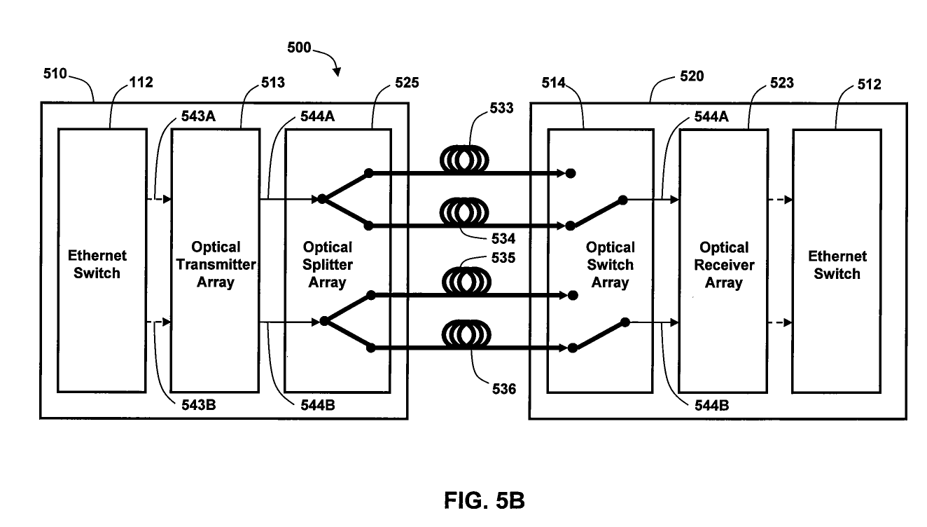

FIG. 5A is a partial block diagram of an optical network 500 configured with optical switches and redundant optical fibers for optical layer protection of two optical links between a transmitting node 510 and a receiving node 520. In this embodiment, optical network 500 is configured with two optical links between each node, such as for a UPSR. The first optical link may serve as the working path between two nodes of the UPSR and the second optical link may serve as the protection path between two nodes of the UPSR. With this configuration, a cut can occur in the working path and in the protection path between two nodes and data traffic will not be substantially interrupted.

Optical network 500 is similar in operation and organization to optical network 400, but with the addition of a second optical link disposed between each node for transmitting a second data stream between transmitting node 510 and receiving node 520, where the second optical link may serve as a protection path for optical network 500. Transmitting node 510 includes an Ethernet switch 112, an optical transmitter array 513, and optical switch array 514, and receiving node 520 includes an Ethernet switch 512, an optical receiver array 523, and a combining optical array 524. As shown, two optical links couple transmitting node 510 and receiving node 520. Ethernet switch 112 transmits electrical output signals 543A, 543B to optical transmitter array 513, and optical transmitter array 513 converts electronic output signals 543A, 543B to optical output signals 544A, 544B, respectively. Optical output signals 544A, 544B are optically coupled to optical switch array 514, which routes optical signals 544A, 544B to receiving node 510 via optical fibers 533 and 535, respectively. In this embodiment, both the working path, i.e., optical fiber 533, and the protection path, i.e., optical fiber 535, of optical network 500 can be damaged between transmitting node 510 and receiving node 520 and continue to operate after only minor packet loss. Receiving node 520 uses optical switch array 514 to remotely reestablish an interrupted optical link with transmitting node 510 for optical output signal 544A and/or 544B in the manner described above for receiving node 420 and optical output signal 444.

Alternatively, as illustrated in FIG. 5B, receiving node 520 may locally reestablish an interrupted optical link with receiving node 520. In this embodiment, receiving node 520 is configured with optical switch array 514 and transmitting node 510 is configured with optical splitter array 525. With such a configuration the optical layer healing process 260 in FIG. 2C, which is a local detection process, can be performed by receiving node 520.

While the foregoing is directed to embodiments of the present invention, other and further embodiments of the invention may be devised without departing from the basic scope thereof, and the scope thereof is determined by the claims that follow.

We claim:

1. An optical network comprising a transmitting node, a receiving node, and first and second optical fibers for carrying optical signals from the transmitting node to the receiving node, wherein the transmitting node is configured to transmit optical signals onto the first optical fiber, and to switch an optical signal transmission path from the first optical fiber to the second optical fiber based on a condition of the first optical fiber.

2. The optical network according to claim 1, wherein switching occurs when the transmitting node detects a break in the first optical fiber.

3. The optical network according to claim 2, wherein the transmitting node includes an Ethernet switch that is used in switching the optical signal transmission path from the first optical fiber to the second optical fiber.

4. The optical network according to claim 3, wherein the transmitting node further includes an optical receiver for receiving input optical signals and generating electrical signals for receipt by the Ethernet switch and an optical transmitter for receiving electrical signals from the Ethernet switch and generating output optical signals for transmission through one of the first and second optical fibers.

5. The optical network according to claim 4, wherein the Ethernet switch is configured to receive electrical signals from the optical receiver and to output electrical signals along one of multiple transmission paths to the optical transmitter.

6. The optical network according to claim 5, wherein the electrical signals comprise Ethernet packets and the Ethernet switch is configured to select a transmission path to the optical transmitter based on headers of the Ethernet packets.

7. The optical network according to claim 3, wherein the Ethernet switch comprises a data buffer for buffering Ethernet packets contained in the electrical signals received from the optical receiver.

8. The optical network according to claim 2, wherein the transmitting node includes an optical switch that is used in switching the optical signal transmission path from the first optical fiber to the second optical fiber.

9. The optical network according to claim 8, wherein the transmitting node further includes an Ethernet switch for receiving electrical signals that contain Ethernet packets, an optical transmitter for receiving electrical signals from the Ethernet switch, generating optical signals from the electrical signals, and transmitting the optical signals for receipt by the optical switch.

10. The optical network according to claim 9, wherein the receiving node includes a combining optic, connected to the first and second optical fibers, for receiving optical signals from the transmitting node through the first and second optical fibers, and combining the optical signals received through the first and second optical fibers into a combined optical signal.

11. A method for protecting against loss of data carried on optical fibers, comprising the steps of:
upon detection of a fault in a first optical fiber, buffering incoming optical data that was received for transmission through the first optical fiber;
switching transmission path for the incoming optical data from the first optical fiber to a second optical fiber; and
transmitting the incoming optical data through the second optical fiber.

12. The method according to claim 11, further comprising the steps of monitoring a power level in the first optical fiber, and detecting the fault when the power level drops below a threshold value.

13. The method according to claim 11, wherein the step of switching is carried out by an Ethernet switch.

14. The method according to claim 11, wherein the step of switching is carried out by an optical switch.

15. The method according to claim 11, wherein the buffered incoming optical data is transmitted through the second optical fiber before additional incoming optical data.

16. An optical network node comprising:
an optical receiver for receiving input optical signals and generating electrical signals therefrom;
an Ethernet switch for receiving electrical signals from the optical receiver and selecting a transmission path based on information extracted from the electrical signals; and
an optical transmitter for receiving electrical signals from the Ethernet switch and generating output optical signals therefrom,
wherein the optical transmitter is connected to a first optical fiber and a second optical fiber, and the Ethernet switch selects the transmission path based on a condition of the first optical fiber.

17. The optical network node according to claim 16, wherein the electrical signals contain Ethernet packets and the information is extracted from headers of the Ethernet packets.

18. The optical network node according to claim 17, wherein the Ethernet switch selects a first transmission path if the first optical fiber is in a normal condition, and a second transmission path if the first optical fiber has been cut.

19. The optical network node according to claim 18, wherein the optical transmitter transmits the output optical signals onto the first optical fiber if the optical transmitter receives the electrical signals from the Ethernet switch over the first transmission path, and the optical transmitter transmits the output optical signals onto the second optical fiber if the optical transmitter receives the electrical signals from the Ethernet switch over the second transmission path.

20. The optical network node according to claim 18, wherein the Ethernet switch receives a data flow control command from a remote node and modifies header information of the Ethernet packets so that the Ethernet packets can be routed to a selected transmission path.
